(19) United States
(12) Patent Application Publication
(10) Pub. No.: US 2004/0197229 A1
(43) Pub. Date: Oct. 7, 2004

(54) Systems and methods for chemical analysis of pool water

(75) Inventor: Robert Roy Runyon, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CEM Maintenance Inc., Englewood, C.O.

(21) Appl. No.: 10/443,689

(22) Filed: May 21, 2003

Related U.S. Application Data
(60) Provisional application No. 60/460,280, filed on Apr. 2, 2003.

(51) Int. Cl. G01N 35/00

(52) U.S. Cl. 422/63

(57) ABSTRACT

The present invention provides systems and methods for chemical analysis of solutions. Some of the systems include a test station with test equipment handling, record maintenance, and solution preparation facilities. In some cases, the test stations are electronically enabled, while in others they are not.

### CROSS REFERENCES TO RELATED APPLICATIONS

This application claims priority to U.S. provisional patent application serial No. 60/460,280, filed on Apr. 2, 2003, and entitled “SYSTEMS FOR PROFESSIONAL WATER TEST STATION,” which is hereby incorporated by reference in its entirety.

### BACKGROUND OF THE INVENTION

The present invention is related to systems and methods that can be used to test the chemical composition of a solution. More particularly, the present invention is related to systems and methods for testing the chemical composition of pool water.

Chemical analysis is performed in a large number of industries. For example, in the pool industry, testing may be performed multiple times a day to assure that chemical concentrations remain at acceptable levels. In some cases, governments have promulgated extensive regulations governing the chemical composition of pools and the frequency at which the chemical composition must be tested. This is in part to avoid the communication of various diseases that can be transmitted through improperly maintained pool water. For example, a form of herpes is commonly communicated through bathing in an improperly maintained hot tub. Unfortunately, the testing of pools is often impeded by the lack of testing facilities. In some cases, tests are performed by placing testing equipment on a filter or other surface near the pool. This ad hoc approach can result in incomplete or spurious readings, or of failure to perform testing altogether.

Not only does this problem pervade the pool industry, but it is also present in a number of other areas where chemical analysis is performed in relation to industrial water treatment including waste water, cooling towers, boilers, fresh water etc. Further, chemical analysis is performed by municipal utilities in relation to both drinking and waste water. Other industries include battery and lead manufacturers, agricultural entities for soil sampling, aquaculture for fish farms, and a number of other uses. Often the analysis in these industries is impeded by improper facilities. Thus, for at least the aforementioned reasons, there exists a need in the art for advanced systems and methods for performing chemical analysis.

### BRIEF SUMMARY OF THE INVENTION

The present invention provides systems and methods that can be used to test the chemical composition of a solution. Some embodiments of the present invention are particularly tailored for use in testing the chemical composition of pool water, and for disposition at or near the location where testing is performed.

Some embodiments of the present invention provide systems for testing solution composition. In some cases, the systems are formed as a test station with features designed to facilitate composition testing. Such systems include a test equipment station, and a solution preparation station that are formed to adjoin. In some cases, the test equipment station and the solution preparation station are formed as a unified molded body. Such a unified molded body can be made of, for example, fiberglass. In other cases, the test equipment station and the solution preparation station are formed such that they can be assembled into a single test station.

In various cases, the test equipment station includes two molded areas—one for receiving a test unit, and the other for receiving a plurality of test vials. The test vials can be used in relation to the test unit to complete solution testing, and in some cases, the molded test vial area is arranged to reinforce test procedures associated with the test unit. Various instances of the test equipment station are formed to hold a variety of test vials, but in one particular embodiment, the test equipment station is designed to hold sixteen test vials—eight in each of two different test vial areas.

Other embodiments of the present invention provide systems for testing pool water. Such systems include a test equipment station, a record station, and a solution preparation station that are unified as a single body. In some cases, the unified body is formed of molded fiberglass, or in some cases a smooth gel coat fiberglass. Further, in various cases, the unified body comprises one or more materials that are non-reactive when contacted by substances including chlorine, bromine, and muriatic acid.

In some instances of the embodiments, the test equipment station includes a molded area for receiving a test unit. Such test units can be, for example, comparators and photometers. The test equipment station can further include a protective cover operable to cover the molded area. Such protective cover can be hinged to the unified body. In some cases, the test equipment station includes an equipment receptacle for accepting a test equipment hookup. Such test equipment hookup can be, but is not limited to, a power cord or a datalink. The datalink can be in the form of a communication cable, or wireless link including, for example, optical or radio frequency links. The datalink can be, for example, a USB link, a firewire link, an RS232 link, an EEE488 link, or the like.

In particular instances of the embodiments, the systems further comprise a storage area at least partially encompassed by at least a portion of the unified body. Such a storage area can be, for example, a shelf mounted under an upper surface of the record station and/or test equipment station. The storage area can be configured to hold or maintain a computer communicably coupled to the datalink. Alternatively, or in addition, the storage area can be configured to hold or maintain one or more reagents used in relation to the solution preparation area.

In various instances of the embodiments, the solution preparation area includes a molded basin with a drain, along with a water source. In various cases, the system includes a leveling mechanism operable to bring a surface of the test equipment station to a level orientation. In some cases, the record station includes a log sheet holder that can include a moveable cover operable to protect a log sheet placed in the log sheet holder. In other cases, the record station further includes an instruction display that can be, for example, an electronic display. Such an electronic display can also be used to display results received from a test equipment mounted in the test equipment station.

Yet other embodiments of the present invention provide methods for manufacturing a test station. The methods include forming a test equipment section and a solution preparation section of a single continuous material such as, for example, plastic or fiberglass. Additional embodiments of the present invention provide test station kits that include a test equipment, and a test station that includes a test equipment station, a record station, and a solution preparation station. Such test equipment stations can further include a computer and a cable operable to communicably coupled the test equipment to the computer.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a top view of a test station in accordance with some embodiments of the present invention;

FIG. 2 is a front view of the test station of FIG. 1;

FIGS. 3 and 4 are side views of the test station of FIG. 1;

FIG. 5 is a component connection diagram of a test station similar to that of FIG. 1 that incorporates electronic connector capability in accordance with particular embodiments of the present invention; and

FIG. 6 is a diagram of a monitoring system in accordance with some embodiments of the present invention.

### DETAILED DESCRIPTION OF THE INVENTION

Various embodiments of the present invention provide systems for testing solution composition. In some cases, the systems are formed as a test station With features designed to facilitate composition testing. Such systems include a test equipment station, and a solution preparation station that are formed to adjoin. In some cases, the test equipment station and the solution preparation station are formed as a unified molded body. Such a unified molded body can be made of, for example, fiberglass. In other cases, the test equipment station and the solution preparation station are formed such that they can be assembled into a single test station. While the present invention is described in relation to a water test station for use in the swimming pool industry, one of ordinary skill in the art will appreciate a number of other uses for the invention.

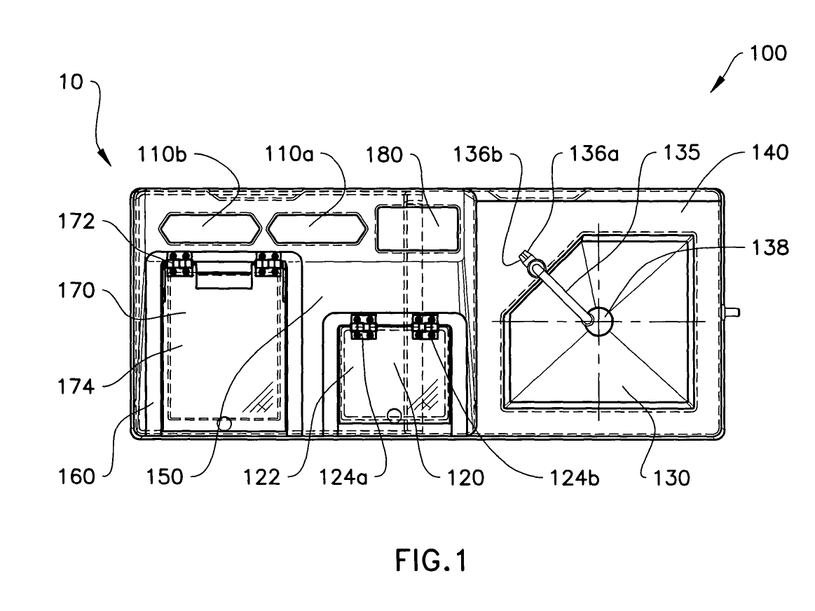

FIG. 1 is a top view 100 of a test station 10 in accordance with an embodiment of the present invention. Test station 10 includes a solution preparation section 140, a test equipment section 150, and a record section 160. In some cases where caustic solutions are prepared and/or tested, it may be desirable to manufacture sections 140, 150, 160 from materials that do not corrode when exposed to such caustic solutions. For example, in the swimming pool industry, a material that does not corrode when exposed to chlorine, bromine, and/or muriatic acid may be desired. In one particular embodiment, sections 140, 150, 160 are molded fiberglass, while in a specific embodiment, the single body is molded non-corrosive FRP smooth gel coat finish material. In other embodiments, sections 140, 150, 160 are formed of plastic. Based on the disclosure provided herein, one of ordinary skill in the art will appreciate a variety of materials that can be used to manufacture sections 140, 150, 160 for a specific application.

In some embodiments, sections 140, 150, 160 are formed as a single body where each of the sections are adjoined in the manufacturing process. For example, test station 10 may be formed of a continuous portion of fiberglass material. In other embodiments, one or more of sections 140, 150, 160 are manufactured as separate pieces and can be subsequently adjoined at a final destination. In some cases, it can be advantageous to manufacture sections 140, 150, 160 as a single body to facilitate shipping, installation, and to assure a minimal foot print. In various cases, test station 10 includes a wall mounting bracket that can allow for custom height requirements. Further, some embodiments of test station 10 are designed to facilitate completion all phases of pool/spa testing and record keeping by a pool operator.

As depicted, solution preparation section 140 includes a basin 130 with a drain 138 located therein. A goose neck faucet 135 with hot and cold water valves 136 is associated with the basin and aids in the preparation of various solutions and the cleaning of various vials. It is advantageous to have a basin and water source near test equipment section 150 as unwashed test vials can lead to improper results and/or other problems. By placing basing 135 near test equipment section 150, a user is encouraged to clean test vials used in the various tests, thus providing for more accurate readings. In some cases, no hot water is provided to solution preparation section 140.

Test equipment section 150 includes a test equipment area 120 that is covered by a clear acrylic cover 122 attached to test equipment section 150 by two hinges 124. Test equipment area 120 includes a level interior surface for maintaining a piece of test equipment in the proper orientation for testing. Further, test equipment area 120 can be formed of a size that accommodates a particular piece of test equipment, or a range of test equipment. Examples of test equipment that can be accommodated in test equipment area 120 include, but are not limited to, a photometer 8000, a photometer 5000, a photometer 7000, a chlorometer 1000, a chlorometer duo, a chlordioxmeter, a clhlordiox duo meter, a micro 500 TDS meter, a micro 500 conductivity meter, a combined waterproof pH/conductivity/TDS meter, a waterproof dissolved oxygen meter, a micro 500 pH meter, an ammonia meter, an ozone meter, a turbidity meter, a molybate duo meter, a comparator kit, a pooltest 3 photometer, a pooltest 5 photometer, a pooltest 9 photometer, each available from PALINTEST LTD. of the United Kingdom. Based on this disclosure, one of ordinary skill in the art will appreciate a variety of other test equipment that can also be placed in test equipment area 120. In one particular embodiment, test equipment area 120 is specifically designed to house a PALINTEST Pooltest 9 Photometer. In another embodiment, the test equipment can be attached through a clamping device to test area 120. In some cases, the test equipment and the test station are packaged together and sold as a kit.

In addition, test equipment section 150 includes an accessory basin 180. Accessory basin can be used to store various accessories related to solution testing. In some embodiments, accessory basin 180 includes a removable cover and a drain. The drain can attach to basin 135, thereby allowing any liquid in accessory basin 180 to be gravitationally transported from accessory basing 180 to basin 135, and out through drain 138. Thus, various accessories can be stored in accessory basin 180, and covered for storage. Further, water can be run over the accessories while the accessories are in accessory basin 180. This allows for quick and easy washing of the various accessories. As previously mentioned, improperly cleaned accessories can lead to false readings, and thus the accommodations for cleanliness found in embodiments of the present invention facilitate proper testing.

Yet further, test equipment section 150 includes two test vial holding areas 110. Test vial holding areas can be molded to hold one or more test vials in an orientation conducive to the tests to be performed. This can be in a level orientation, or at an angle depending upon the test to be performed. In one particular case, storage for four test vials in a level (straight up) orientation is provided in each of test vial holding areas 110. In some cases, the orientation of the test vials is controlled by the molding of test vial areas 110, while in other cases, a molded insert is placed in test vial holding areas 110 to hold various test vials. In some cases, the molded insert is prepared such that the test vial holders are arranged in an order that reinforces a test procedure to be implemented in relation to test station 10.

Record section 160 includes a record area 170 that is covered by a clear acrylic cover 174 attached to record section 160 by two hinges 172. In some embodiments, record area 170 is designed to hold a log sheet that can be filled in by an operator using some writing instrument. In other embodiments, record area 170 includes a video or LCD display that can include instructions for performing a test and/or results of a test. In some cases, the display is a touch screen display that allows an operator to electronically record, accept, verify, and/or modify test results using a stylus. The test results can be communicated directly from the test equipment to the display, or indirectly via a computer communicably coupled to both the test equipment and the display.

A minimal foot print is helpful to facilitate the location of tests station 10 near a pool in an existing pool house. Such proximity eases the testing process, and assures that the testing process is more likely to occur. In one particular embodiment, a minimal foot print includes basin 130 that is approximately fifteen inches by seventeen inches in cross section, and about nine inches deep. Storage area 220 is approximately twenty inches wide, fourteen inches tall, and twenty inches deep. Test equipment area 120 is approximately eight inches by six and one-half inches in cross section, and about 2 and three-eighths inches deep. Record area 170 is approximately twelve inches by eleven inches in cross section. In one embodiment, the upper surface of test equipment section 150 and record section 160 slope at an angle approximately the arcsine of one-third.

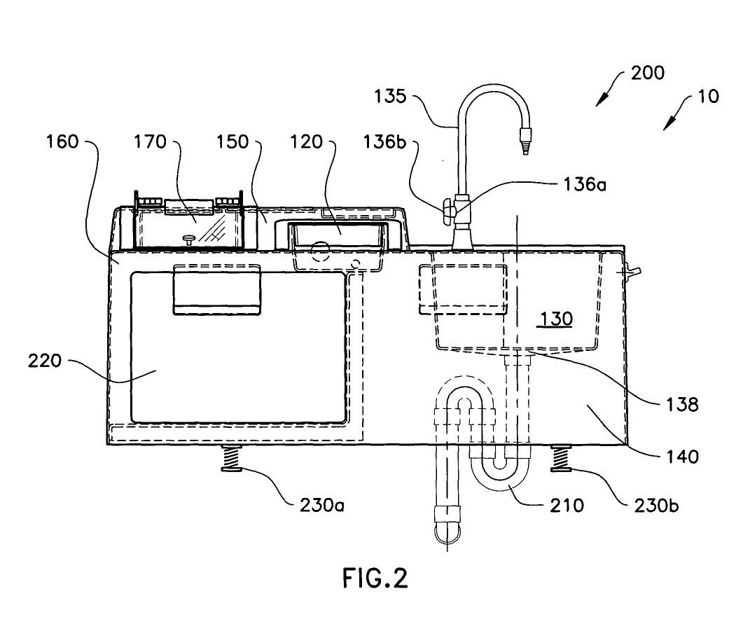

Turning to FIG. 2, a front view 200 of test station 10 is illustrated. In addition to the previously described elements of test station 10, a storage area 220 is provided below test equipment section 150 and record section 160. Storage area 220 can be segmented to hold a computer useful in relation to the testing processes and reagents and other chemicals used in the testing process. In some embodiments, storage area 220 is open, while in other embodiments, a hinged door (not shown) covers storage area 220. In addition, a drain pipe 210 can couple an external drain to drain 138 of basin 130. Test station 10 can also include leveling controls 230 operable to adjust the orientation of test station 10.

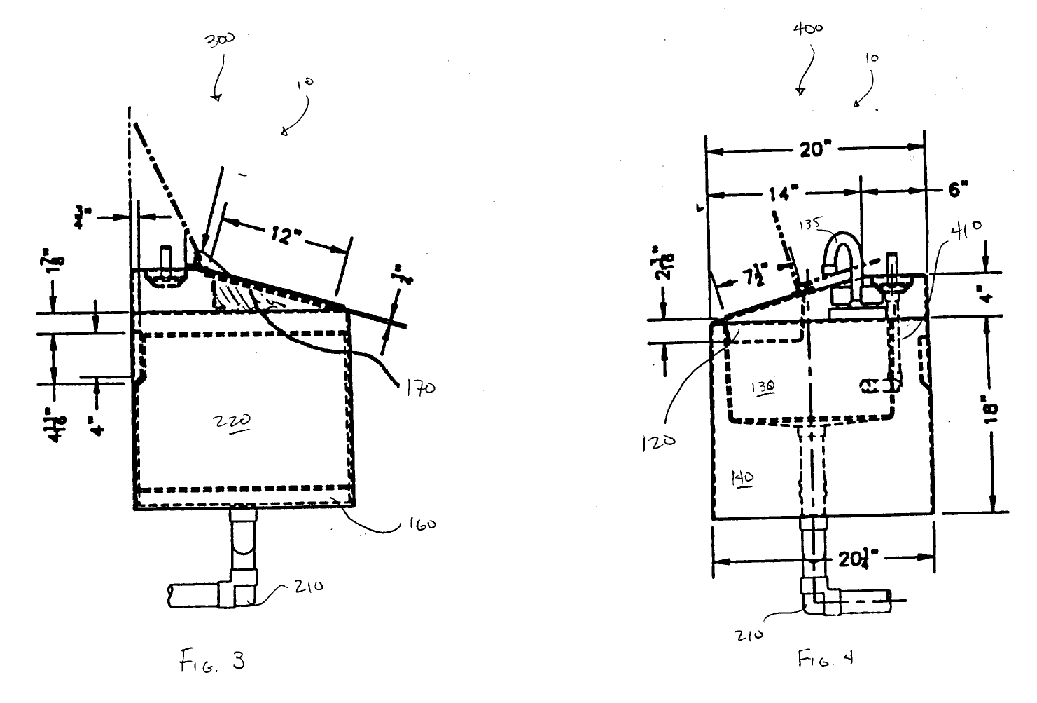

Turning to FIG. 3, a left side view 300 of test station 10 is depicted. Left side view 300 illustrates the slanted top of test equipment section 150 and record section 160. This angle provides a variety of advantages. For example, when liquids are spilled on the surface of test equipment section 150 and/or record section 160, the liquid drains off the surface without any effort on the operator's part. In addition, the angle precludes storage of items on test station 10. Thus, when an operator desires to start a test, he is not required to first remove items from test station 10. Record area 170 is also shown in left side view 300. As illustrated, record are 170 has a level interior surface protected under the acrylic cover. FIG. 4 depicts a right side view 400 of test station 10. As illustrated, test equipment station 120 is disposed within tests station 10 similar to that previously discussed in relation to record area 170. This can be important as various test equipment operate more effectively when deployed in a level orientation. Also shown is the drain 410 leading from accessory basin 180 to basin 130.

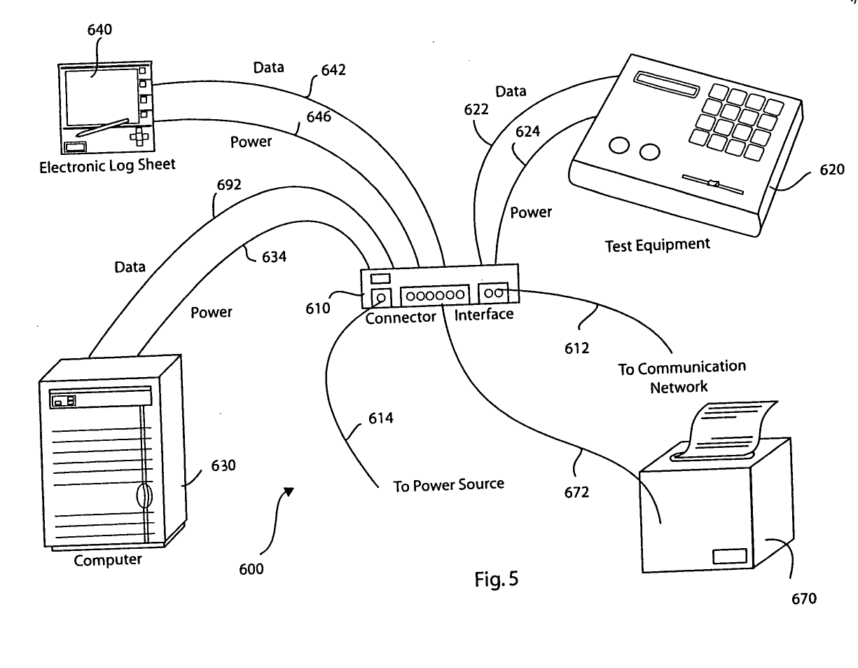

Some embodiments of the present invention are electronically enabled. FIG. 5 provides a schematic diagram 600 of such an electronically enabled test station. Included is a connector interface 610 that can include power and data distribution ports. In some embodiments, connector interface 610 is distributed to three locations. Part of connector interface 610 is located at the back of storage area 220 and includes power 634 and data 632 connections for a computer 630. Another part of connector interface 610 is located on the back vertical wall of test equipment area 120 and includes power 624 and data 622 connections for a test equipment 620. Yet another part of connector interface 610 is located on the back vertical wall of record area 170 and includes power 644 and data 642 connections for an electronic log sheet 640. Based on the disclosure provided herein, one of ordinary skill in the art will appreciate that connector interface 610 can be mounted in a number of different ways, or together as a single interface. Further, one of ordinary skill in the art will appreciate that the electronic log sheet may be replaced by another type of electronic display and/or input device, or by a pad of paper. Yet further, one of ordinary skill in the art will appreciate that one or more of computer 630, test equipment 620, and/or electronic log sheet 640 may or may not be included, or that other components may be included. Further, a printer 670 can be communicably coupled to computer 630, test equipment 620, and/or electronic log sheet 640 via a communication link 672. Printer 670 can print various test reports.

In one particular embodiment, data connections 622, 632, and 632 are Universal Serial Bus connections allowing for communication between electronic log sheet 640 and computer 630, and between test equipment 620 and computer 630. In addition, connector interface 610 can include a data connection 612 communicably coupling the test station to a communication network. Further, a power source 614 is provided that can connect the test station to a power source such as, for example, a 120V AC outlet. In one particular embodiment, data connection 612 is a WiFi connection as is known in the art.

In operation, a test can be performed using test equipment 620. Instructions for the test can be displayed on electronic log sheet 640 along with the test results received from test equipment 620. A user can use the stylus to accept the test results, in which case the test results are stored electronically on a computer readable medium associated with computer 630. Electronic log sheet 640 may also display a range a acceptable test results, and based on these ranges, the operator may decide to run the test again to assure the accuracy of the results before recording the results.

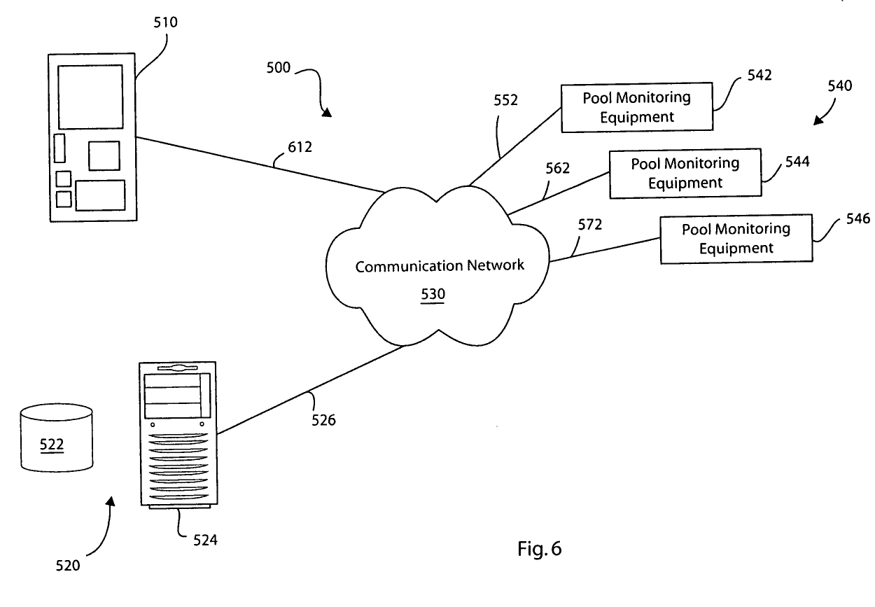

In some cases, the results can be communicated to an external storage area via connection 612. FIG. 6 depicts a system 500 where such a process is carried out. System 500 includes an electronically enabled test station 510 communicably coupled to a communication network 530 via data connection 612. System 500 further includes a pool monitoring set 540 comprising one or more pool monitoring equipment 542, 544, 546. Such pool monitoring equipment can include, for example, temperature sensors, water level sensors, chemical sensors, pool area humidity and temperature sensors, filter operation sensors, and/or the like. Pool monitoring equipment 542, 544, 546 can be individually coupled to communication network 530 via data links 552, 562, 572. Alternatively, pool monitoring equipment 542, 544, 546 can be communicably coupled to a computer (not shown) that is in turn communicably coupled to communication network 530. System 500 also includes a monitoring server 520 that includes a CPU 524 and a computer readable medium 524. Monitoring server 520 can be communicably coupled to communication network 530 via datalink 526.

Communication network 530 can be any communication network capable of providing communications between the various elements of system 500. In some embodiments, communication network 530 is the Internet providing message based communication between test station 510 and monitoring server 520, and between pool monitoring equipment set 540 and monitoring server 520. In other embodiments, communication network 530 comprises a TCP/IP compliant virtual private network (VPN). In yet other embodiments, communication network 530 includes the Internet for communication between test station 510 and monitoring server 520, and a VPN between pool monitoring equipment set 540 and monitoring server 520. However, it should be recognized that other communication networks could be used to provide similar functionality. For example, communication network 530 can be a local area network (LAN), a wide area network (WAN), a telephone network, a cellular telephone network, a virtual private network (VPN), the Internet, an optical network, a wireless network, or any other similar communication network or combination thereof.

In operation, pool monitoring set 540 monitors various attributes of a pool and periodically, or on an alarm basis, reports the sensed status of the pool to monitoring server 520 via communication network 530. Further, the results of periodic tests run by an operator using test station 510 can also be communicated to monitoring server 520 via communication network 530. Monitoring server 520 can maintain a record of the results on computer readable medium 522. Further, in some cases, monitoring server 520 can forward instructions to pool monitoring set 540 to cause changes in the status of the pool. For example, an instruction to increase a chemical level can be sent. Thus, a pool can be monitored, and in some cases controlled remotely.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for testing solution composition, the system comprising:
a test equipment station;
a solution preparation station; and
wherein the test equipment station and the solution preparation station are formed to adjoin.

2. The system of claim 1, wherein the test equipment station and the solution preparation station are formed as a unified molded body.

3. The system of claim 1, wherein the test equipment station includes:
a first molded area for receiving a test unit; and
a second molded area for receiving a plurality of test vials.

4. The system of claim 3, wherein the second molded area is arranged to reinforce test procedures associated with the test unit.

5. The system of claim 3, wherein the second molded area is formed to hold at least four test vials.

6. A system for testing pool water, the system comprising:
a test equipment station;
a record station;
a solution preparation station; and
wherein the test equipment station, the record section, and the solution preparation station are formed as a unified body.

7. The system of claim 6, wherein the test equipment station includes a molded area for receiving a test unit.

8. The system of claim 7, wherein the test unit is selected from a group consisting of: a photometer and a comparator.

9. The system of claim 7, wherein the test equipment station further includes a protective cover operable to cover the molded area.

10. The system of claim 9, wherein the protective cover is hinged to the unified body.

11. The system of claim 6, wherein the test equipment station includes an equipment receptacle for accepting a test equipment hookup.

12. The system of claim 11, wherein the test equipment hookup is a power cord.

13. The system of claim 11, wherein the test equipment hookup is a datalink.

14. The system of claim 13, wherein the datalink is selected from a group consisting of: a USB link, a serial link, an RS232 link, an IEEE488 link, a wireless link, and an optical link.

15. The system of claim 13, wherein the system further comprises:
a storage area at least partially encompassed by at least a portion of the single unified body, wherein the storage area is operable to maintain a computer communicably coupled to the datalink.

16. The system of claim 6, wherein the solution preparation area includes a molded basin with a drain.

17. The system of claim 16, wherein the solution preparation area further includes a water source.

18. The system of claim 6, wherein the unified body is formed of molded fiberglass.

19. The system of claim 6, wherein the unified body is formed of a material that is non-reactive when contacted by substances selected from a group consisting of: chlorine, bromine, and muriatic acid.

20. The system of claim 6, wherein the system further comprises:
a storage area at least partially encompassed by at least a portion of the single unified body, wherein the storage area is operable to maintain one or more reagents used in relation to the solution preparation area.

21. The system of claim 6, wherein the system further comprises a leveling mechanism operable to bring a surface of the test equipment station to a level orientation.

22. The system of claim 6, wherein the record station includes a log sheet holder.

23. The system of claim 22, wherein the record station further includes a moveable cover operable to protect a log sheet placed in the log sheet holder.

24. The system of claim 6, wherein the record station further includes an instruction display.

25. The system of claim 24, wherein the instruction display is an electronic instruction display.

26. The system of claim 6, wherein the record station further includes an electronic display of results received from a test equipment mounted in the test equipment station.

27. A method for manufacturing a test station, the method comprising:
forming a test equipment section;
forming a solution preparation section; and
wherein the test equipment section and the solution preparation section are formed of a single continuous material.

28. The method of claim 27, wherein the single continuous material is fiberglass.

29. A test station kit, wherein the test station kit comprises:
a test equipment; and
a test station, wherein the test station includes:
a test equipment station;
a record station; and
a solution preparation station.

30. The test station kit of claim 29, wherein the test station kit further comprises:
a computer; and
a cable for communicably coupling the test equipment to the computer.
